(19) United States
(12) Patent Application Publication
(10) Pub. No.: US 2021/0357893 A1
(43) Pub. Date: Nov. 18, 2021

(54) SYSTEMS AND METHODS FOR COMMERCE IN A DISTRIBUTED SYSTEM WITH BLOCKCHAIN PROTOCOLS AND SMART CONTRACTS

(71) Applicant: YellowHeart LLC, New York, NY (US)

(72) Inventors: Jimmy C. KANG, Warren, NJ (US); Evan Kress FROHLICH, Astoria, NY (US); Joshua KATZ, New York, NY (US)

(21) Appl. No.: 17/129,958

(22) Filed: Dec. 22, 2020

Related U.S. Application Data
(63) Continuation of application No. 16/688,610, filed on Nov. 19, 2019, now abandoned.
(60) Provisional application No. 62/902,806, filed on Sep. 19, 2019.

(51) Int. Cl. G06Q 20/12; G06Q 20/36; G06Q 20/02; G06Q 20/38; G06Q 10/02

(52) U.S. Cl. CPC G06Q 20/1235; G06Q 20/3674; G06Q 2220/00; G06Q 20/389; G06Q 10/02; G06Q 20/02

(57) ABSTRACT

The present disclosure relates generally to systems and methods for using a distributed ledger (e.g., blockchain) to create an online ticketing platform for the buying and/or selling of authenticated live event tickets. More specifically, exemplary embodiments of the present disclosure relate to systems and methods for creating a blockchain-based online ticketing platform that may be decentralized, that may be public, and that may be transparent to a buyer and/or seller of live event tickets (e.g., sporting events, concerts, theatrical productions, and other live entertainment events). An exemplary embodiment may include a system for electronic commerce in a distributed computing system with blockchain protocols and smart contracts that may comprise: a decentralized, public, and permission-less online platform for the electronic commerce of secure digital assets, wherein the secure digital assets are managed by the blockchain protocols and smart contracts; and a truth source.

### CROSS-REFERENCE TO RELATED APPLICATIONS

This application is a continuation of U.S. patent application Ser. No. 16/688,610, filed Nov. 19, 2019, which claims the benefit of priority under 35 U.S.C. § 119(e) to U.S. Provisional Patent Application No. 62/902,806, filed Sep. 19, 2019, all of which are herein incorporated by reference in their entirety.

### TECHNICAL FIELD

The present disclosure relates to an online platform for commerce in a distributed system with blockchain protocols and smart contracts. The online platform may be used for the commerce of authenticated digital assets (e.g., digital collectibles, live event tickets), may be decentralized, may have the ability to control a transaction(s) end-to-end, may have the ability to regulate or control participant activity on the platform, and may have the ability to recapture revenue from sales of the authenticated digital assets on primary and/or secondary markets.

Various embodiments of the present disclosure relate generally to systems and methods for using a distributed ledger (e.g., fully decentralized blockchain, partially decentralized blockchain, etc.) to create an online platform for the buying and/or selling of collectibles. In an exemplary embodiment, and as taught throughout this disclosure, the online platform is an online ticketing platform for the commerce (e.g., buying, selling, transferring, etc.) of authenticated live event tickets. In an exemplary embodiment, systems and methods for using a distributed ledger (e.g., fully decentralized blockchain, partially decentralized blockchain, etc.) for commerce with blockchain protocols and smart contracts are disclosed, and include the ability to control end-to-end commerce so that revenue on primary and/or secondary markets may be recaptured and distributed in a controlled and orderly manner (e.g., controlled by a rule set or rule sets) to different participants in a commercial transaction, a private transaction, a peer-to-peer transaction, or a machine-to-machine transaction.

More specifically, exemplary embodiments of the present disclosure herein relate to systems and methods for creating a blockchain-based online ticketing platform that may be fully decentralized, that may be completely public, and that may be entirely transparent to a buyer and/or a seller of live event tickets (e.g., sporting events, concerts, theatrical productions, and other live entertainment events).

### BACKGROUND

The live event ticket industry engages in tens of billions of dollars in transactions each year. Examples of live events requiring a ticket include, but are not limited to, sporting events, concerts, theatrical productions, and other live entertainment events. Online ticket exchanges proliferate the Internet with exchanges to buy and/or sell event tickets for these live events. However, buyers and/or sellers in the secondary market often run up the cost of the ticket for these live events (e.g., sporting events, concerts, theatrical productions, and other live entertainment events). In some instances, bots, or other nefarious actors, buy live event tickets with the only intention of re-selling them at a higher cost in the hope of making a profit. For example, a bot may drive up the cost on an online ticketing platform only to re-sell the live event ticket to the end purchaser (i.e., an actual person buying the ticket with the sole purpose of attending the live event) at a higher price. While recent legislation, including the 2016 Better Online Ticket Sales (“BOTS”) Act, has been passed, bots, and other nefarious actors, continue to rampantly drive up the cost of these live event tickets.

In the 2000s, ticket exchanges began utilizing digital technologies and/or personal computing equipment (including mobile devices, tablets, etc.) to switch from paper tickets to digital tickets. With the immense adoption of mobile devices, such as smart phones, the need to purchase digitally deliverable tickets online has become more common and more in demand by ticket purchases or users of digital delivery ticketing platforms. However, as mentioned, the secondary market, including bots and other bad-faith actors, tend to be a cause of driving ticket prices up nearly 50% on average, and, in some cases, the ticket price can be raised by more than 1,000% of the original ticket price. Furthermore, authentication of these online digitally deliverable tickets (e.g., counterfeit or fraudulent tickets) also becomes a concern. Some other issues with these digitally deliver tickets for live events include: predatory secondary markets, high and/or hidden fees, minimal data availability to the purchaser, and counterfeit and/or speculative ticketing. Forgers, speculators, bots, scalpers, and other bad third-party actors will continue to thrive so long as a marketplace permits such abuse. Current marketplaces are opaque, unregulated, mis-priced, from which third-party actors benefit the most.

In some instances, unauthorized brokers use bots to scrape ticket information, check inventory, and rapidly purchase or hold tickets as soon as they become available. This technique is referred to as “spinning”, which is used by nefarious actors, such as bots, to effectively block fans from accessing affordable tickets. In doing so, the fans are forced to pay inflated prices on secondary markets.

Therefore, a need exists to create an authenticated, public, secure online ticketing platform for an online marketplace for the buying and/or selling of live event tickets that disrupts secondary markets and disincentivizes bots and/or scalpers.

Furthermore, much of the revenue generated by ticket sales may often be collected by third parties (e.g., scalpers) and not the original artists.

Therefore, a need exists for systems and methods that provide the ability to control end-to-end commerce so that revenue on secondary markets can be recaptured and re-distributed in a controlled and orderly manner to different participants in the transaction(s). A need also exists for systems and methods that provide the ability to control end-to-end commerce so that revenue on primary markets can be distributed to market participants in real-time in accordance with pre-set rules.

### SUMMARY

Embodiments of the present disclosure relate to, among other things, systems and methods for using a distributed ledger (e.g., blockchain) to create an online ticket platform for the buying and/or selling of authenticated live event tickets. More specifically, particular embodiments of the present disclosure relate to systems and methods for creating a blockchain-based online ticketing platform that is decentralized, completely public, and may be entirely transparent to a buyer and/or seller of live event tickets (e.g., sporting events, concerts, theatrical productions, and other live entertainment events) and may disrupt secondary markets and disincentivizes bots and/or scalpers.

Embodiments disclosed herein relate to public platforms that may utilize fully or partially decentralized blockchains. For example, in an embodiment utilizing a fully decentralized blockchain, the identity of a user and/or payment information may be authenticated using blockchain protocols and smart contracts.

The present disclosure describes systems and related methods that provide the ability to control end-to-end commerce so that revenue on secondary markets may be recaptured and re-distributed in a controlled and orderly manner to different participants in the transaction(s). The embodiments herein may be applicable to any good or service that may be represented as a digital asset, such as, for example, live event tickets, collectibles, souvenirs, collector items, merchandise, food/beverage, limited-edition products, designer clothing, etc.

Embodiments disclosed herein also relate to systems and methods that provide the ability to control end-to-end commerce so that revenue on primary markets may be distributed to market participants in real-time in accordance with pre-set rules.

Both the foregoing general description and the following detailed description are exemplary and explanatory only and are not restrictive of the features, as claimed. As used herein, the terms “comprises,” “comprising,” “including,” “having,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.”

In one exemplary embodiment, the embodiment is a system. This exemplary system may be an online system for electronic commerce in a distributed computing system with blockchain protocols and smart contracts, which may comprise: a decentralized public permission-less online platform for the electronic commerce of secure digital assets, wherein the secure digital assets may be managed by the blockchain protocols and smart contracts; and a truth source, which may allow for authentication and verification of identity and/or payment information in a public, decentralized system.

In one exemplary embodiment, the embodiment is a method. This exemplary method may comprise the steps of: selling a secure digital live event ticket as a non-fungible token to a consumer through an online platform, wherein the live event ticket may correspond to a specific live event, and wherein information and rules regarding said live event ticket may correspond to at least one smart contract that may be stored on a decentralized public, permission-less online system with blockchain protocols. The method may also comprise one or more of the following steps: receiving a request from an application software or digital wallet that resides on a consumer's electronic device to authorize payment for a ticket to a specific live event; sending an authorization verification request to a payment processor; receiving a transaction identifier from the payment processor; sending the received transaction identifier to the at least one smart contract that corresponds to the requested specific live event, which resides on the public blockchain; sending a message including the transaction identifier from the at least one smart contract to a decentralized oracle network; receiving a message from the decentralized oracle network that verifies the purchase; and releasing the secure digital live event ticket as a non-fungible token corresponding to said requested ticket to a specific live event to said consumer's application software or digital wallet.

In another exemplary embodiment, the embodiment is a method. This exemplary method may comprise: a method of creating a secure digital live event ticket on an online platform, wherein said live event ticket may correspond to a specific live event, wherein information and rules regarding the sale and resale of said live event ticket may correspond to at least one smart contract that may be stored on a decentralized public, permission-less system with blockchain protocols, and wherein said rules regarding the sale and resale of said live event tickets may be enforced by the online platform. The method may include one or more of the following steps: creating a live ticket event that corresponds to a specific live event, at a specific date and time and at a specific face-value price; specifying the rules regarding the sale and resale of said live event ticket; and codifying such rules in the at least one smart contract deployed on the public blockchain, which corresponds to said live event ticket.

In another exemplary embodiment, the embodiment is a method. This exemplary method may comprise: a method of creating a secure digital live event ticket as a non-fungible token on an online platform, wherein said live event ticket may corresponds to a specific live event, wherein information and rules regarding how revenues for the sale or resale of said live event ticket may be distributed among multiple parties may correspond to at least one smart contract that is stored on a distributed decentralized public, permission-less system with blockchain protocols, and wherein said rules regarding how revenues for the sale or resale of said live event ticket may be distributed among multiple parties are enforced by the online platform. The method may include one or more of the following steps: creating a live ticket event that corresponds to a specific live event, at a specific date and time and at a specific face-value price; specifying the rules regarding how revenues for the sale or resale of said live event ticket are distributed among multiple parties; codifying such rules in the at least one smart contract deployed on the public blockchain, which corresponds to said live event ticket; and upon sale or re-sale of any said live event ticket, distributing the revenues among the multiple third-parties in accordance with said rules.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure. In the figures:

FIG. 1 is a flow diagram illustrating a system for using a distributed ledger (e.g., blockchain) that is decentralized to create an online ticket platform for the buying and/or selling of authenticated live event tickets, in accordance with an exemplary embodiment of the present disclosure;

FIG. 2A is a flow diagram illustrating an exemplary wallet of a payment processing system of the system depicted in FIG. 1, in accordance with an exemplary embodiment of the present disclosure;

FIG. 2B is a flow diagram of an exemplary payment processing transaction using blockchain protocols and smart contracts of the system depicted in FIG. 1, in accordance with an exemplary embodiment of the present disclosure;

FIG. 3 is a flow diagram of an exemplary smart contract stored on a plasma decentralized layer II sidechain of the blockchain depicted in FIG. 1, and shown to be in communication with an exemplary decentralized (DC) node, in accordance with an exemplary embodiment of the present disclosure;

FIG. 4 is a flow diagram of an exemplary implementation of the decentralized blockchain using the plasma decentralized layer II sidechain, in accordance with an exemplary embodiment of the present disclosure;

FIG. 5 is a flow diagram illustrating a system for using a distributed ledger (e.g., blockchain) that is partially decentralized to create an online ticket platform for the buying and/or selling of authenticated live event tickets, in accordance with an exemplary embodiment of the present disclosure;

FIG. 6 is a schematic diagram illustrating the system of FIG. 1 being used by multiple participants of the system (e.g., platform), including: fans, artists, promoters, third-party ticket re-sellers, and venues, in accordance with an exemplary embodiment of the present disclosure;

FIG. 7 is a schematic diagram illustrating the plasma layer sidechain of FIGS. 3 and 4 depicting its attachment to an exemplary blockchain (e.g., main Ethereum blockchain) via a transfer gateway, in accordance with an exemplary embodiment of the present disclosure;

FIG. 8 is a flow diagram of an exemplary federated biometric-based user identification system for added security of the system shown in FIG. 1 such that the biometric-based ID may be used to secure and recover wallets or purchased tickets during use of the system shown in FIG. 1, in accordance with an exemplary embodiment of the present disclosure;

FIG. 9 is a flow diagram of an exemplary anti-bot application used by the system shown in FIG. 1, such that the anti-bot application may be used to address unauthorized brokers, e.g., bots and scalpers, from driving up ticket prices in the system shown in FIG. 1, in accordance with an exemplary embodiment of the present disclosure; and

FIG. 10 is a flow diagram of an exemplary implementation of “token” flow using the system shown in FIG. 1, in accordance with an exemplary embodiment of the present disclosure.

### DETAILED DESCRIPTION

While the present disclosure is described herein with reference to illustrative embodiments for particular applications, it should be understood that embodiments of the present disclosure are not limited thereto. Other embodiments are possible, and modifications can be made to the described embodiments within the spirit and scope of the teachings herein, as they may be applied to the above-noted field of the present disclosure or to any additional fields in which such embodiments would be of significant utility. For example, embodiments described herein can be used with any good and/or service that can be represented digitally.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, patent documents, whitepapers, and technical papers referred to in this document or in the attached appendices are incorporated by reference in their entirety herein, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The present disclosure relates to an online platform for commerce in a distributed system with blockchain protocols and smart contracts. In an embodiment, “online” may refer to any online platform controlled by or connected to another computer or to a network, and that may be accessed or controlled by a device (e.g., laptop, smartphone, desktop computer, tablet, or any device with a network access. In one embodiment, the online platform may be configured to operate over an Internet-of-Things (e.g., an interconnection via the Internet of computing devices embedded in everyday objects, enabling them to send and receive data).

In an exemplary embodiment, the online platform may be used for the commerce of authenticated digital assets (e.g., digital collectibles, live event tickets), as taught herein. The online platform may be completely public such that trust of using the platform and authentication of identity and payment information is ensured. The online platform may have the ability to control a commercial transaction(s) end-to-end. In other words, the online platform may retain the ability to control a transaction from end-to-end (e.g., from origination/creation to final sale). In an exemplary embodiment, the online platform may have the ability to regulate or control participant activity on the platform, and may have the ability to recapture revenue from sales of the authenticated digital assets (e.g., digital collectibles, live event tickets) on secondary markets.

The embodiments taught throughout this disclosure may also be used to mitigate “distressed inventories”. For example, in an exemplary embodiment of the platform, tokens, as taught herein, may be used to mitigate un-sold tickets on the platform for a specific live ticket event. In such an event, rules may be modified in associated “smart contracts”, as taught herein, to address to the un-sold tickets, for example, by dropping the price of the ticket. It can be appreciated that the platform may be used for similar purposes to control the end-to-end commerce of a live event ticket.

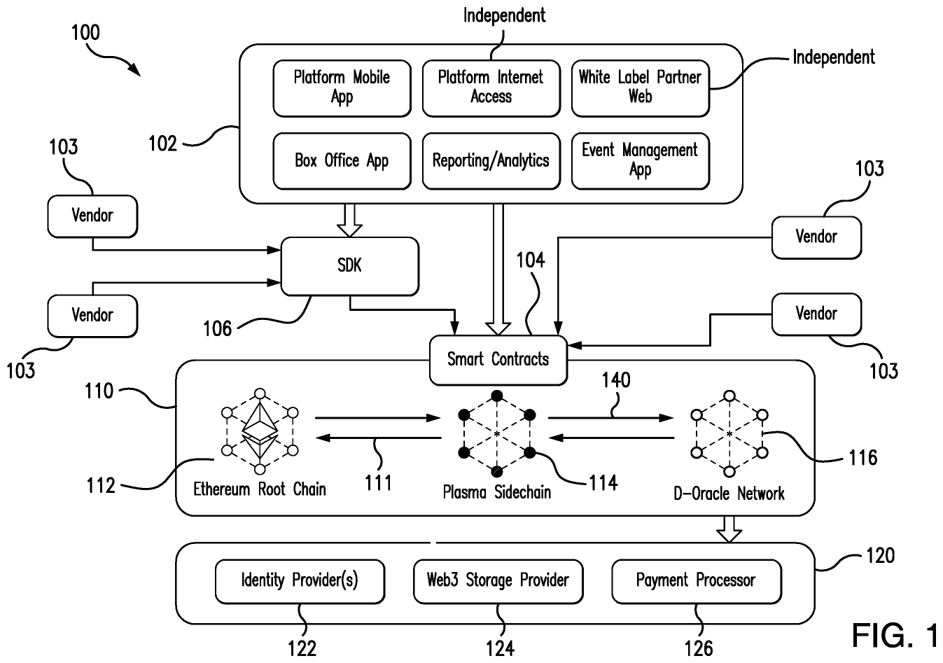

In an exemplary embodiment, the online platform may be fully or partially decentralized. An example of a fully-decentralized embodiment of the platform is depicted by FIG. 1. Some advantages of using a fully decentralized blockchain-based platform for online end-to-end commerce includes: always being on a globally distributed computing network; transparency of all transactions; and allowing for maximum marketplace participation by independent parties (e.g., 3rd parties). The fully decentralized platform may be referred to as a system that is completely or totally public. The term “permission-less” may be used to describe a totally public, fully decentralized platform, as taught herein. In the a totally public system, that is fully decentralized, there is no need for an entity in the system to grant “permission” to another party or entity to join the totally public system. In other words, a central authority granting or denying access to join the platform does not exist in a “permission-less” based system since the system is entirely public. “Permission-less” systems, which may be referred to as fully distributed systems, are trustless environments. An advantage of such a system with a trustless environment is so that no single entity (e.g., operator/owner of the platform or system, etc.) oversees, or is in charge of, the platform or system. Verification and/or security measures, therefore, are more complex in such a public, trustless system to ensure integrity and/or compliance during operation or use of said system.

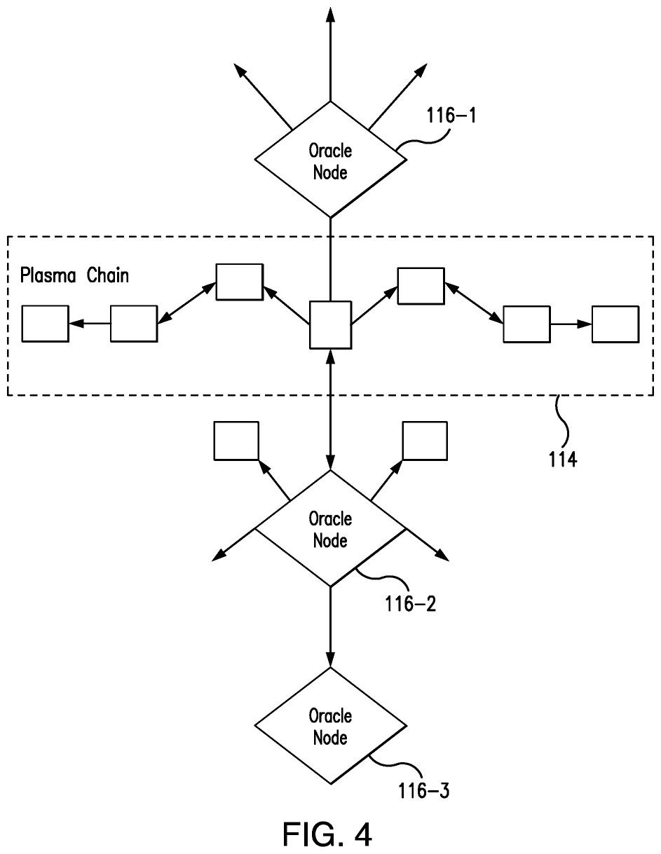

An example of a partially decentralized, “permission-based” blockchain platform is depicted in FIG. 5. The platform shown in FIG. 5 is not a “permission-less” system. A partially decentralized blockchain-based platform operates similarly to the fully decentralized version of the platform except for that participation on the partially decentralized version may require authorization by the operator/owner of the platform (e.g., YellowHeart). Some advantages of using a fully decentralized blockchain-based platform for online end-to-end commerce includes: certain infrastructure components would be managed by the operator (e.g., YellowHeart) and/or participating partners; limiting the full public transparency offered by the decentralized approach; and requiring 3rd parties to request permission to use the platform in advance of being able to do so.

Various embodiments of the present disclosure relate generally to systems and methods for using a distributed ledger (e.g., fully decentralized blockchain, partially decentralized blockchain, etc.) to create an online platform for the buying and/or selling of collectibles. In an exemplary embodiment, and as taught throughout this disclosure, the online platform is an online ticketing platform for the commerce (e.g., buying, selling, transferring, etc.) of authenticated live event tickets. In an exemplary embodiment, systems and methods for using a distributed ledger (e.g., fully decentralized blockchain, partially decentralized blockchain, etc.) for commerce with blockchain protocols and smart contracts are disclosed, and include the ability to control end-to-end commerce so that revenue on primary and/or secondary markets may be recaptured and distributed in a controlled and orderly manner (e.g., controlled by a rule set or rule sets) to different participants in a commercial transaction.

More specifically, particular embodiments of the present disclosure relate to systems and methods for creating a blockchain-based online ticketing platform that is fully decentralized, completely public, and entirely transport to a buyer and/or seller of live event tickets (e.g., sporting events, concerts, theatrical productions, and other live entertainment events).

With specific reference now to the figures, the present disclosure is directed to an online platform for commerce in a distributed system with blockchain protocols and smart contracts. FIG. 1 depicts an event ticket sales platform 100. In an embodiment, the platform 100 may be referred to as a system. In an exemplary embodiment, the platform 100 may be used to establish an immutable, secure, verifiable digital asset or item (e.g., digital live event ticket) that can only be surrendered or redeemed by an authorized assignee on the platform. The systems and methods described herein may be operable on a platform, which may be referred to as the “YellowHeart Platform” or “platform”. However, it can be appreciated that the systems and methods described herein may not necessarily be used for the buying and/or selling of live event tickets, and that other uses of the platform may be desirable. Using a decentralized public distributed ledger, such as a blockchain, the sale or exchange of tickets may be conducted in a highly secure and highly transparent manner without the requirement of a third-party intermediary. In an exemplary embodiment, the ticket exchange system draws on blockchain, for example, blockchain protocols and smart contracts. In an exemplary embodiment, the platform draws on an entirely public blockchain.

The term “current owner”, as used herein, may refer to the owner of an item (e.g., digitally deliverable ticket, digital event ticket, live event ticket, etc.) at a given point in time. The ownership interest of the item may change over time.

The term “live event ticket”, as used herein, may refer to a ticket for admission to a sporting event, concert, theatrical production, or any other live entertainment event for which a ticket is required for admission.

The term “non-fungible” token, as used herein, may refer to a live event ticket that has been tokenized, as taught herein. Non-fungible tokens may refer to actual ticket seats at a live event. For example, a non-fungible token may refer to a seat in a specific section of a stadium or arena, having a specific row and seat number, and valid for only that date. Non-fungible tokens are designated for a specific event instance and seat assignment. Non-fungible tickets are never the same, and each non-fungible ticket is distinct from other non-fungible tickets. For example, a non-fungible ticket to “Event A on Dec. 20, 2019, Section 102, Row 4” is unique to that event and that seat; a duplicate non-fungible ticket to that event and that seat does not exist since no two non-fungible tokens are the same. In an exemplary embodiment, a rule set may be created by the event originators to control the sale, purchase, transfer, etc. of the non-fungible token by the event originator. In an exemplary embodiment, the event originator can be the original artist, the promoter, the production company, the producer, and/or some related party tasked with creation of a live ticketing event.

The terms “YellowHeart tokens” (“YHT”) and “YellowHeart dollars” (“YHD”), as used herein, are exemplary types of “fungible tokens.” “Fungible tokens” are not unique; they may be used as currency. Both YHT and YHD may refer to fungible tokens that are dividable or divisible, for example, like currency. These fungible tokens may refer to money in a user's systems (e.g., in an account of a user using the platform taught herein). In other examples, YHT may refer to tokens that emulate rewards that may be redeemed by a user (e.g., fan) that utilizes the platform, as taught herein. In an exemplary embodiment, YHT may correspond to a distribution waterfall intended to incentivize desired user behavior, such as, for example, increased ticket purchases, identity verification, and/or artist promotions, etc. Multiple types of YHT may be used or utilized by the system. YHD, in an exemplary embodiment, may refer to dollars, Bitcoin, Ethereum currency, or some other cryptocurrency that may be used for ledger entry to re-distributing money to artists. An artist may defined as, at least, the performer and/or any party affiliated with the live event (e.g., a promoter, a bank, a producer, a performing artist, management, executives, agents, owners or operators of the venue in which the live event is to occur, etc.). It can be appreciated YHD may used to re-distribute money generated by the sales of tickets on the platform taught herein back to any party that participates or should participate in the economics and/or the revenue sharing of the event in accordance with pre-set rules that are set for each particular non-fungible token (e.g., live event). In an exemplary embodiment, a rule set may be created by the event originators to control the distribution and/or re-distribution of money, tokens, rewards, etc.

Both fungible tokens, such as YHT and YHD, and non-fungible tokens are governed in the platform taught herein by “smart contracts.” See, for example, Ethereum White Paper: https://github.com/ethereum/wiki/wiki/White-Paper/f18902f4e7fb21dc92b37e8a0963eec4b3f4793a. A “smart contract”, as taught herein, is the basic immutable rule set and defines the fundamentals of what that token is and its properties and rules for how it may interact with a fully or a partially decentralized blockchain. For example, ERC-721 and ERC-20 are examples of contracts that may be used an immutable rule set to define the properties of the fungible tokens and the non-fungible tokens of the present disclosure. The rule sets that define these tokens are embodied in the “smart contracts” itself. In an exemplary embodiment, tokenized IDs, for example, may be stored directly on a “smart contract.”

The term “user”, as used herein, may refer to a user of the platform, as taught herein, and include a fan, a consumer, a token holder (e.g., YHT holder, YHD holder, etc.).

While the platform taught herein may be used for creating a marketplace for ticketing (e.g., live event tickets), it can be appreciated that the systems, methods, and/or platform described herein may be configured to be used for any type of commerce requiring end-to-end control using a public blockchain. For example, the platform taught herein may be used to transact any product or service that can be digitally represented, anything that may require identification verification (e.g., biometrics, etc.), or any other rule-based commerce using blockchain protocols and smart contracts. Identification verification may include, but is not limited to, authentication of a user (e.g., fan) using the platform to determine if the user is a real human, and not a bot, or, separately to determine is a scalper. Examples of ways the platform may also be used are for: physical or digital collectibles (e.g., artwork, rare coins, luxury goods, limited designer wear, such as sneakers and limited run clothing) or any collectible item that can be represented as digital token. Digital collectible (e.g., electronic ticket stubs to a famous live event attended by a user, such as the Super Bowl or World Series), may also utilize the features and/or functions of the platform taught herein. Collectables are often bought and sold on secondary markets and have similar needs for provenance and buyer/seller verification. The platform taught herein may be used to control end-to-end ticketing, but may be used for any end-to-end commerce that can use a digital token using a blockchain. Partial or complete revenue lost during such end-to-end commerce may be recouped by setting rules on the platform, including pre-set rules to control the end-to-end commerce using blockchain protocols and smart contracts, and smart contracts for non-fungible tokens. In such scenarios, the platform taught herein may be used to track collectibles from origination to a final sale without loss of integrity, and by tracking its market value (e.g., re-sell value) in secondary markets. An advantage of the platform described herein is that it may be used to re-distribute revenue from third parties to event participants (e.g., artists performing a live event, promoters of the live event, and/or other live event creators, etc.).

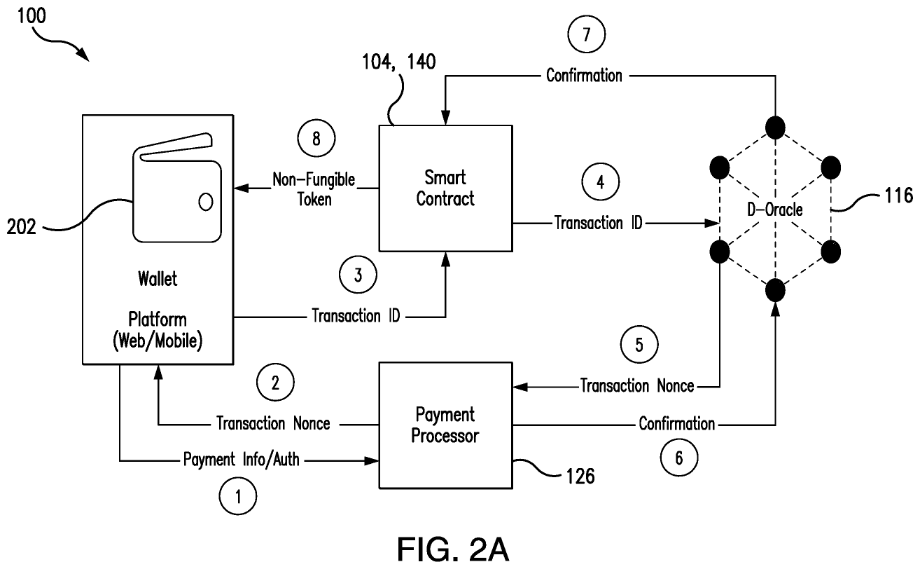

The platform 100 may be directed to an event ticket sales system and related methods that convert a traditional paper or electronic ticket into an immutable digital asset that can only be surrendered or redeemed by an authorized assignee or owner. The ticket system may be securitized such that, while public, can be authenticated and provide trust, transparency of pricing, and transparency in the end-to-end transaction of the digital product or service (e.g., the non-fungible token digitally representative of a specific seat at the live event). In an exemplary embodiment, the digital asset may be referred to as a non-fungible token, and may be populated in a user's digital wallet (e.g., digital ticket wallet stored on a user's smartphone). An exemplary wallet 202 is illustrated in FIG. 2A, which utilizes the platform via a mobile or web-based access point. Non-fungible tickets, as taught herein, which correspond to individual live events may be populated in the digital wallet 202, in an embodiment.

In an exemplary embodiment, the wallet 202 of the system 200, as shown in FIG. 2A, may be a software component, which stores cryptographic key pairs and that may be used to interact with smart contracts for tracking ownership, transferring, buying and selling of digital tokens on the platform 100 (e.g., ERC-721 non-fungible tokens).

In an exemplary embodiment of the platform 100 taught herein, by using cryptographic key pairs, the sale or exchange of non-fungible tokens may be conducted in a highly secure and highly transparent manner without the requirement of a third-party intermediary. A blockchain is secure as long as honest nodes collectively control more CPU power than any cooperating group of attacker nodes. Transactions that are computationally impractical to reverse may protect sellers from bad actors who may attempt to act on their behalf, and routine escrow mechanisms are implemented to protect buyers.

To leverage a blockchain for tickets, each ticket may undergo a tokenization and securitization process. FIG. 2A depicts an illustrative example of a series of steps 1-8 that correspond to a user using the platform taught herein to purchase a non-fungible token (e.g., ticket to a specific live event). Each non-fungible token, as described herein, may be controlled by a pre-determined rule set. Each rule set may be created by the live event originators or creators. The steps of FIG. 2A may also be used by the platform for validating identity, as taught later herein.

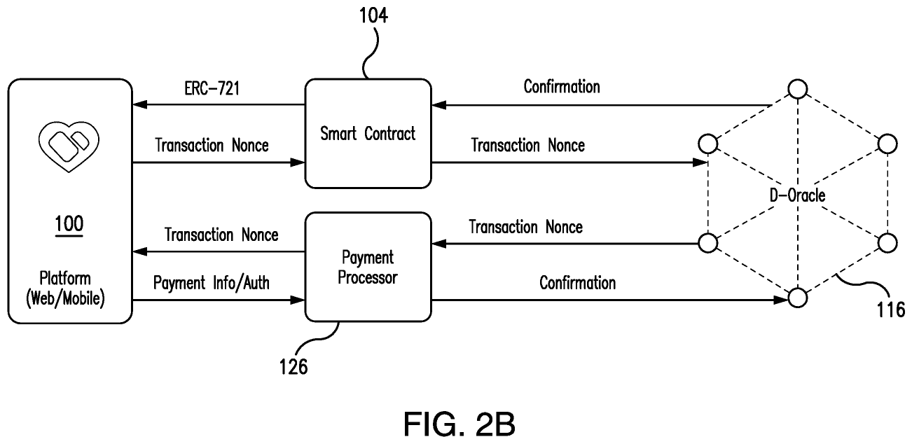

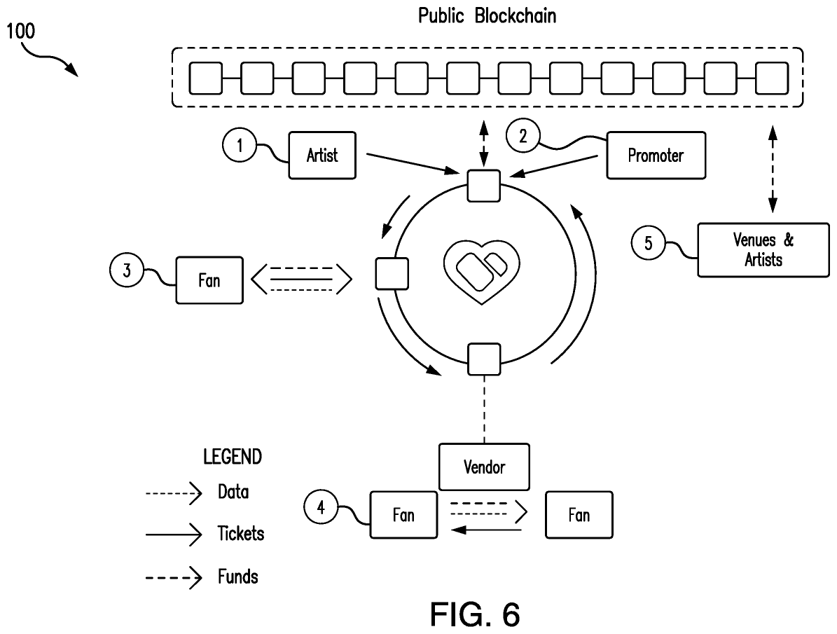

Described in detail herein is a blockchain-based online ticketing platform that is decentralized, completely public, and entirely transparent to a buyer and/or seller of live event tickets (e.g., sporting events, concerts, theatrical productions, and other live entertainment events). Systems and methods described herein relate to a decentralized blockchain-based online ticketing platform that may achieve trust between the user community using openness, provide transparency of operation, and create a ticketing platform on which all ticket data is stored “on-chain” (referring to the blockchain). In an exemplary embodiment, one of the platform's key objectives in using a public, decentralized platform is to achieve public ticket “provenance.” “Provenance”, as taught herein, relates to data provenance where all inputs, transactions and state changes are recorded and used as a guide for authenticity and accuracy. The decentralized platform may be configured to achieve a high level of performance, including, but not limited to: a high transaction volume, fast finality (i.e., fast transaction validation, consensus agreement, and commitment to the blockchain) and a low rate of error. In an exemplary embodiment, and with reference now to FIGS. 3, 4, and 7, the implementation of a decentralized blockchain may use a plasma decentralized layer II sidechain 114. As taught herein, a plasma layer 2 sidechain 114 attaches to a main blockchain 112 (e.g., Ethereum) via a transfer gateway 111, as shown in FIG. 7. In an embodiment, the transfer gateway 111, which consists of smarts contracts on the side and main chains, as well as on an oracle relaying inter-chain events generated on either side, provides the means to transfer digital assets between the chains and commit transaction hashes (i.e., Merkle tree root hashes) to the main chain. During operation, the plasma decentralized layer II sidechain may be capable of running an alternate consensus algorithm able to handle transactions (e.g., on the online ticketing platform taught herein) more efficiently. The plasma decentralized layer II sidechain may also be configured to build added trust and security. For example, the plasma chains may be guaranteed in the main chain (e.g., Ethereum chain) using one or more plasma contracts. These plasma contracts secure side chain transactions by periodically committing Merkle tree hashes from the side chain onto the main. In an exemplary embodiment, the plasma decentralized layer II sidechain may be advantageous for: speed, scalability, security, efficiency, user (e.g., consumer) friendliness, and compatibility and interoperability. For example, the plasma decentralized layer II sidechain may be configured to scale thousands of requests per second. In an embodiment, the plasma decentralized layer II sidechain may offer near instant transaction finality with Delegated Proof of Stake (DPoS) consensus. In DPoS consensus, holders of network issued tokens will periodically elect validator nodes entrusted with verifying transaction correctness. The periodic election process acts as a form of digital democracy, eliminating the need for complicated, energy inefficient algorithms such as Proof of Work. For scalability, the plasma decentralized layer II sidechain may be configured such that applications on the platform (e.g., DApps) may run on their own “shard”. In an exemplary embodiment, the plasma decentralized layer II sidechain may be secured by Ethereum Mainnet. The plasma decentralized layer II sidechain may also not require or need complicated proofs, which in turn may reduce waste and unwanted expense. The plasma decentralized layer II sidechain may be configured such that the platform taught herein may delegate a “stake” on behalf of users of the platform; thus, removing the requirement for users to have tokens (e.g., Ethereum) in their digital wallets. Lastly, the plasma decentralized layer II sidechain may be configurable with the “smart contracts”, as taught herein. These “smart contracts” may be written in the Solidity programming language to provide 100% compatibility with Ethereum Mainnet and any other EVM-based chains. Moreover, fungible tokens, non-fungible tokens, and/or ETH may be moved seamlessly between Ethereum and the plasma decentralized layer II sidechain.

A challenge with a decentralized platform, as described above, is identity verification in a large, decentralized and public ecosystem. That is, in a publicly accessible online platform, anyone may use the public platform to create a hostile environment. For example, the capture and storage of Personally Identifiable Information (PII), credit card payment information, PCI compliance, and/or any other valuable user information must be secure when using the platform. A decentralized oracle network, as taught in additional detail later in this disclosure, is one solution. In an exemplary embodiment, the decentralized oracle network may be used as a truth source. In an exemplary embodiment, the blockchain-based platform, as taught herein, may include features for improved security, including identification and data security. Features of identity and data security may include, but are not limited to: third party identity verification, encryption of personally identifiable information (PII) in a secure database off-chain, cryptographically signed requests, upgradeable “smart contracts” scheme, as taught herein, and regular security audits.

As taught herein, the system may include a central computing system that may generate master cryptographically verifiable ledger represented by a sequence of blocks. Each block in the master cryptographically verifiable ledger may contain one or more transactions records. Each subsequent block may contain a hash value associated with the previous block. The central computing system can be in communication with independently operated systems/domains. The central computing system can receive an event associated with at least one physical object or item, as taught herein. In an exemplary embodiment, the event may be a sale or purchase of a ticket, or some other transaction related to the platform described herein. In response to receiving the event, the central computing system can generate an additional block in the master cryptographically verifiable ledger. The additional block can contain one or more new transaction records associated with the event.

The central computing system can determine which of the independently operated domains are affected by the event captured in the one or more transaction records included in the one additional block. The central computing system can transmit an alert to the independently operated domain(s) affected by the one or more new transaction records to notify at least one independently operated domain of the generation of the at least one additional block in the master cryptographically verifiable ledger. The independently operated domains each maintain a separate and distinct sub cryptographically verifiable ledger represented by a sequence of sub-blocks specific to the respective independently operated domain. For example, an independently operated domain can receive the alert and verify the event. The independently operated domain can generate an additional sub-block in a sub cryptographically verifiable ledger associated with the independently operated domain. The sub-block can contain the one or more transaction records associated with the event and a hash value associated with the additional block in the master cryptographically verifiable ledger as well as a hash value to the previous block in the sub cryptographically verifiable ledger associated with the independently operated domain.

FIG. 1 is an exemplary schematic of an event ticket securitization system 100 using a distributed ledger (e.g., blockchain). The system 100 may be referred to as a “platform” throughout the disclosure. The system 100 is a combination of decentralized infrastructure that includes identity verification (e.g., buyer or seller of a live event ticket), and security and/or authentication features to provide integrity to a sale of a live event ticket from end-to-end (e.g., the original point of sale and creation to the final sale to be used for admission to the live event). System 100 may include one or more user applications 102 stored and/or accessible via a mobile phone (e.g., smart phone) or any other suitable Internet-based device (e.g., laptop, desktop computer, tablet, etc.). In an exemplary embodiment, the system 100 may configured such that one or more third-party vendors 103 (e.g., Spotify, TicketMaster, StubHub, SeatGeek, etc.) may interact with the system 100 according to aspects of the disclosure taught herein.

In an exemplary embodiment of the architecture for the platform 100, the platform may include: a proprietary mobile application and event management systems; a public DPoS (Delegated Proof of Stake) Ethereum layer II sidechain; a decentralized oracle network or service; a distributed file system; a third party identity verification and payment processing system; and the capability to permit easy reseller integration via the “smart contracts”, as described herein.

FIG. 1 depicts a plurality of applications, including the platform application, partner websites, event management application, box office application, reporting/analytics application, and others. Application(s) 102 may be accessed by a user (e.g., buyer and/or seller of the live event ticket) to gain access to the system 100. In an exemplary embodiment, SDK 106, in FIG. 1, may consist of one or more software libraries and/or services that are offered to provide enhanced functionality above and beyond traditional blockchain systems. For example, in an embodiment, translation of API schemes to other common protocols, e.g., REST; data caching for faster data lookup and retrieval; and higher order API that bundles multiple smart contract interactions. It can be appreciated that other examples of such software libraries and/or services may be used by the platform. Upon accessing the system 100, “smart contracts” 104 may be leveraged using a blockchain 110. The “smart contracts” 104 may represent an item, such as a live event ticket. To leverage the blockchain, each ticket or “smart contract” 104 may undergo a tokenization and securitization process. As taught herein, the “tokenized” live event ticket is referred to as a “non-fungible ticket.” These non-fungible tokens, as taught herein, may be restrained or controlled by a rule set. Some examples of the rule set for the non-fungible tokens used by the platform herein are: ERC-721 and ERC-20. ERC-20 is an example of a contract or a rule set or an interface that the non-fungible token must be able to interact with. These rule sets are immutable. In an example, this may include the obfuscation of the barcode that is required for entry. Traditionally, this barcode is generally printed directly on to the face of a printed ticket.

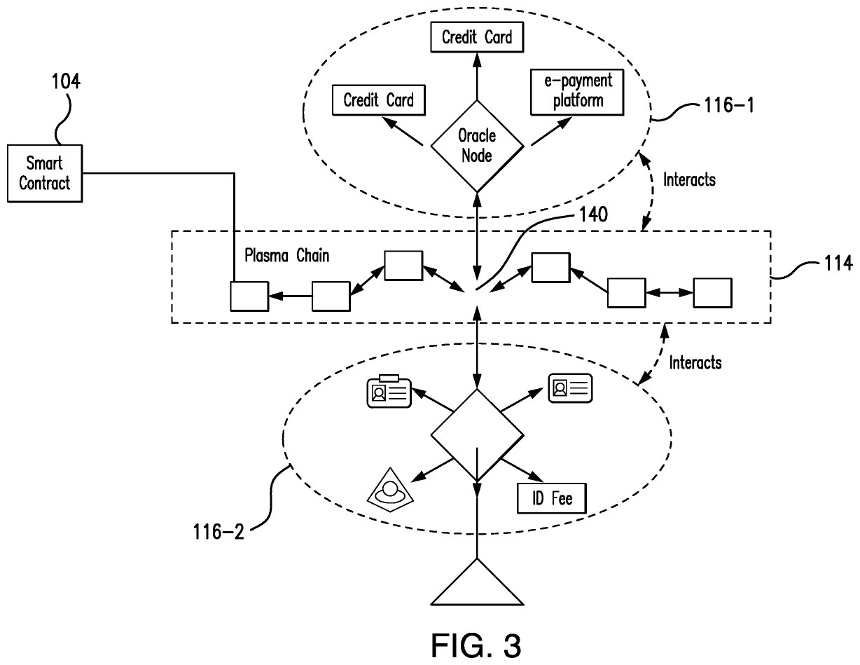

In an exemplary embodiment, and with reference to FIG. 2A, more than one smart contract will be in communication with another smart contract. In other words, more than one smart contract will be talking to each other. In an exemplary embodiment, each of the smart contracts utilized by the platform may be deployed on the blockchain. For example, and as shown in FIGS. 3 and 4, a smart contract 104 is deployed or stored onto the blockchain 114. A smart contract 140, on the blockchain 114, is shown to be communicating with a decentralized (DC) node 116-1. During operation of the platform taught herein, DC nodes are not tied to a specific function. In other words, on any given DC node 116, a transaction may be processed. For example, on any given DC node, payment and/or ID may be processed. With respect to what is depicted in FIG. 3, DC node 116-1 corresponds to a DC node on which a payment is being processed, which may be used by the platform to effectuate payment services (e.g., using a major credit card or e-payment service, such as PayPal or Venmo, to settle balances when purchasing tickets on the platform). Smart contract 140, also shown in FIG. 3, is configured to communicate with a second decentralized (DC) node 116-2, on which ID information is being processed. It can be appreciated that multiple transactions may be processed on the same DC node (e.g., payment and ID on a single node) or may be processed on different DC notes (e.g., 116-1,116-2, 116-3 of FIGS. 3 and 4). The ID node transaction process may correspond to the one or more identification features utilized by the platform, as taught herein, to determine that a user (e.g., fan) is the true user and/or to determine that a user is not a nefarious user or bad actor using the platform (e.g., ticket scalper or bot). It can be appreciated that DC nodes 116-1 and 116-2 are shown as illustrative example and are not limiting. Additional or fewer DC nodes may be used to effectuate the one or more features or aspects of the Yellow Heart platform. In other words, the DC nodes may be used to inject and/or validate data sourced from authorities external to the blockchain network.

As described herein, all smart contracts, for example 104 or 140 in FIGS. 1 and 2, may be deployed or stored on the blockchain. As such, smart contracts, as taught herein, may be distributed to every computer on the blockchain. Each individual block on the chain will retain a copy of this smart contract such that the smart contracts, and by extension the rule set of each smart contract, is guaranteed by the blockchain 110, as shown in FIG. 1.

The steps outlined in FIG. 2A, which are used to process a payment, may also be used to verify identity. In an exemplary embodiment, for each smart contract, as taught herein, the level of identity may be defined (e.g., super fan, regular fan, below average fan, bot, scalper, etc.). For example, if a user of the platform is seen buying and re-selling tickets 100% of the time, the platform may determine that this user is a scalper. If so, the identified scalper's permissions on the platform may be reduced, modified, blocked, and/or controlled. In some cases, the user may be permanently banned from using the platform. In some cases, the platform may limit the overall % of tickets for a specific live event (e.g., number of non-fungible tokens) that can be sold to scalpers on the platform.

The present disclosure also describes systems and methods that allow for the capture and management of identity information about buyers. The systems and methods described herein allow sellers to use that information to offer sales of digital assets (e.g., live event tickets, or any other non-fungible tokens) to one or more particular classes of buyers. This allows third parties, or any user of the platform, to access smart contracts, and directly offer the digital assets (e.g., live event tickets, or any other non-fungible tokens) to a particular class of users. For example, performing artists (e.g., Beyoncé Knowles, Taylor Swift, etc.), and/or their respective promoters, will be able to use this feature of said systems and methods to mint a new non-fungible token to a class of potential buyers identified by the platform as super fans of that particular artist (e.g., Beyoncé Knowles super fans, Taylor Swift super fans, etc.). this same feature allows sellers to restrict and/or control classes of buyers that may purchase a given digital assets (e.g., live event tickets, or any other non-fungible tokens). This may be used to prevent or control the percentage of bots and/or scalpers that may be permitted to purchase the number of tickets for a specific live event.

In an exemplary embodiment, the platform may be configured such that a smart ticket contract can “talk to” or communicate with a smart user contract. In an embodiment, varying or differing smart contracts can be set up such that each smart contract has a different set of rules stored on it. Each rule set may cater to a fan-side experience, or user-side experience, or event-side experience, etc. Each rule set may be used by the platform to govern how a user, a fan, etc. is allowed to participate on the platform.

With continuing reference to FIGS. 2A and 2B, a transaction ID or transaction identifier, as taught and depicted through the present disclosure, may be referred to as a transaction nonce. According to an exemplary embodiment, a nonce is a verification of a transaction. A nonce may be used in general cryptographic results. For example, in FIG. 2A, the transaction nonce or ID is used to confirm payment and to ultimately issue a non-fungible token (e.g., an actual live event ticket) into a wallet 202 of a user (e.g., a fan).

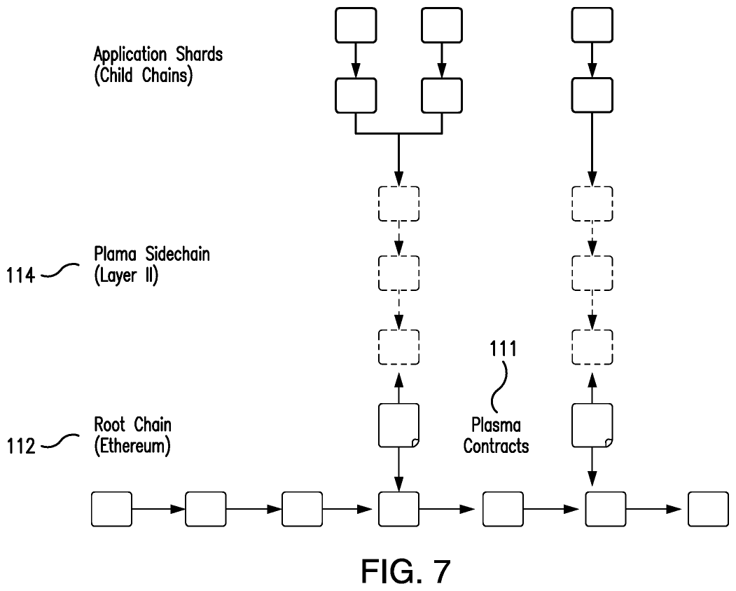

In an exemplary embodiment, and with continuing reference to FIG. 1, the blockchain 110 may be comprised of an Ethereum root chain 112, a plasma sidechain 114, and a decentralized network 116 (e.g., decentralized oracle network or “D-oracle network”). The root chain 112 (e.g., Ethereum or any other suitable root chain), the plasma sidechain 114, and the D-oracle network 116 may be interoperably communicative with respect to each other, as depicted in FIG. 1. FIG. 8 is an illustrative example of the root chain (e.g., Ethereum) 112, plasma contracts 111, and the plasma sidechain 114, all of which are also referred to in the blockchain 110 of FIG. 1. FIG. 7 further depicts an additional “sharding” feature of the platform taught herein (e.g., Application shards or child shards). Furthermore, the system 100 may include one or more identity providers 122, one or more web storage providers 124, and one or more payment processors 126. In an exemplary embodiment, and according to aspects of the present disclosure, the D-oracle network 116 provides a number of advantages. For example, the D-oracle network 116 may allow for the security and determinism of the “smart contracts”, taught herein, to be combined with the knowledge and breadth of real-world external events. In an exemplary embodiment, the “oracle network”, as taught herein, may be referred to as a “truth source”. A “truth source” may be any entity in which the platform has to verify with an external source regarding a transaction or event. In other words, because the platform described herein is public, the truth source may be needed to verify or confirm the truth of a user's identity, or a user's transaction, or any event that may require verification with the outside world to confirm if it true (e.g., confirm the user saying he/she is “X” is actually “X” and not “Y” or not a bot; confirm if the payment transaction is verifiable, etc.). The D-oracle network 116 may provide an interface, for example, for connecting these “smart contracts” to a data source and APIs on which they rely on for proper functioning. The D-oracle network 116 may be configured to send payments from the “smart contracts” to bank accounts and/or payment networks (e.g., Visa, PayPal, MasterCard, etc.). The D-oracle network 116 may also provide a means for interacting with identity providers controlled by a user.

This “oracle network”, as taught herein, may solve the “oracle problem”. The “oracle problem” may occur any time or instance a need arises to verify something (e.g., a transaction's detail, identity, payment processing, etc.) in the external world. For example, to return a value to the platform to verify its truth. In scenarios where a third party is using the platform taught herein, the “truth source” or D-oracle network 116 may be utilized by the platform to authenticate an interaction between the third party and the platform, and subsequently, if verified by the truth source or oracle network, transmit that verification to the blockchain to complete the transaction (e.g., if the payment information was verified, then allow the user to purchase the digital ticket or non-fungible token; or if the user's identity was determined by the oracle as true, then allow the user to access the platform to purchase the digital ticket or non-fungible token). In the context of the systems described throughout the present disclosure, a “secure digital event ticket” may be referred to as a token, and, more specifically, a non-fungible token.

With continuing reference to the D-oracle network 116 of the blockchain 110 of the system 100, and as shown in FIGS. 1 and 2A, the payment processor 126 may be operatively connected to the D-oracle network 116, as described herein. An exemplary embodiment, shown as a diagrammatic flow chart in FIG. 2A, is provided to describe and depict the function between the YHT system, described above, the “smart contracts” 104, the payment processor 126, and the D-oracle network 116.

The system 100 may utilize D-oracle network 116 to overcome problems related to the “oracle problem” as known in the industry. Generally, a smart contract has no knowledge of reality or external events, and so the smart contract must rely on a truth source, aka “an oracle”, for it to receive external data. While the execution of this contract may be trustless in traditional methods, the D-oracle network 116 of the system 100 may be used to achieve trust between the external provider and ensure that the data that it provides is not compromised. In other words, the decentralized oracle network provides another layer of validation for external data providers providing proofs (e.g. TLS Notary) that the retrieved data did indeed come from the trusted source and has not been tampered with. In the present system 100, the D-oracle network 116, in conjunction with the Ethereum root chain 112 and the plasma sidechain 114, may be used to verify the information on the smart contracts.

The D-oracle network 116, as described and depicted herein, may provide a bridge from the “smart contract” 104 to the external (i.e., outside) world, and the D-oracle network 116 may be able to do so without relying on a centralized infrastructure.

In general, D-oracle networks function by providing a contract to be deployed on a user's network. This contract may act as an API layer to the D-oracle network 116. Whenever a contract needs to reach or access an external source, the contract may utilize this API layer by calling the relevant API method. Ultimately, it is the API contract that emits an event. In an exemplary embodiment, the D-oracle network's 116 nodes may listen for these events and may compete to execute their encoded instructions. Upon executing their encoded instructions, the results may be sent back to a sender contract's callback method and a small fee is paid to the executing node. Aspects of the system 100 described and depicted herein, may take advantage of one or more of the above aspects of the D-oracle network and its nodes.

For example, in the exemplary embodiment shown in FIG. 2A, the payment processor 126 in conjunction with the D-oracle network 116 may be referred to as an e-commerce payment flow. In this embodiment, at a first step, the application 102 (e.g., the user's wallet) may authorize a charge with the payment processor 126. At a next step, the payment processor 126 may return a transaction nonce or transaction identifier, as taught herein. At a subsequent step, the transaction nonce is sent to the “smart contract” 104, as depicted in FIG. 1. At a step, the “smart contract” 104, now having received the nonce, subsequently may then emit a message indicating to the oracle, that payment details for the specified nonce must be verified. The D-oracle network 116 receiving a message containing the transaction nonce, and, subsequently, may confirm the transaction nonce with the payment processor. At a next step, the D-oracle network 116 may then send a confirmation back to the sender's contract's callback method. At a last step, the “smart contract” 104 may then release the token/ticket to the user's wallet. Once released, the token/ticket may be used by the user (e.g., the user may attend the live event, such as a sporting event, using this released token/ticket.

### “Open Ticket” Marketplace

The platform or system 100 may operate as an “open ticket marketplace” or “OTM”. This OTM may be a decentralized ticket exchange that may permit or allow artists, venues, and promoters to define one or more rules on how tickets sell and resell. In doing so, the system may allow all parties the ability to participate in primary and secondary sales and/or exchanges. Additionally, the OTM may permit artists, venues, promoters, etc. to gain the ability to create an “event” (e.g. concert, sporting events, other live entertainment event, etc.) and “mint” tickets for the given event on to a public blockchain. An exemplary blockchain 110, described above, may be utilized for this purpose.

The rules defined by the ticket “minter” for each ticket are encoded as “smart contracts” 104 and deployed onto the blockchain 110. The “Rules” may include but are not limited to the following:

Max ticket markup on resale;

Number of tickets allowed per fan;

% of ticket markup to by split with the seller;

Permission settings for allowing tickets to be sold for a percentage less the face in the case the show has not sold out by a given date and time;

Setting a refund policy;

Deterring or preventing the participation of bots and/or scalpers;

Deterring or preventing the participation of third-party nefarious actors (e.g., human or non-human; and

Setting a permission for allowing affiliate sales.

It can be appreciated that other “Rules” may be generated as needed.

The OTM may also allow a user (e.g., a fan of a sports team) to set preferences around preferred seating locations before official “on-sales”.

In yet another feature of the OTM, when tickets, as taught herein, go “on sale”, each ticket may be distributed algorithmically based on user ticket preferences, fan score (e.g., how likely each fan is a real fan, and not a bot and/or scalper), rewards points, order submitted, etc. In an exemplary embodiment, the OTM may be configured such that each user (e.g., a fan) may opt in to including secondary ticket resales as part of their preferences. For example, if a ticket subsequently becomes available that may meet the user's preferences at a given price range, then the user will be awarded those tickets.

In yet another feature of the OTM, and likewise, a user (e.g., fan) may opt to resell their tickets in the OTM. In an exemplary embodiment, the user selects or sets a minimum price the user is willing to accept for a given ticket. The OTM will then attempt to match seller and buyer preferences based on this setting. Tickets may be sold immediately or later up until the time of the event. Moreover, sellers may withdraw tickets from the OTM at any time assuming the seller has not sold the ticket(s).

In still another feature of the OTM, the OTM may be configured such that it may permit or facilitate easy peer-to-peer transfers from one participant to another.

### Token Operability

The system 100 may be utilized to create propriety tokens. These tokens, as described above, may be referred to as non-fungible tokens (e.g., digital replacements for traditional paper tickets used for admission to a live event) and fungible tokens (e.g., YHT or YHD, as taught herein), which may act as currency. YHT, YHD and the non-fungible event tokens may all be codified as “smart contracts” and designed to interoperate allowing YHT to be used and/or awarded while purchasing an event ticket.

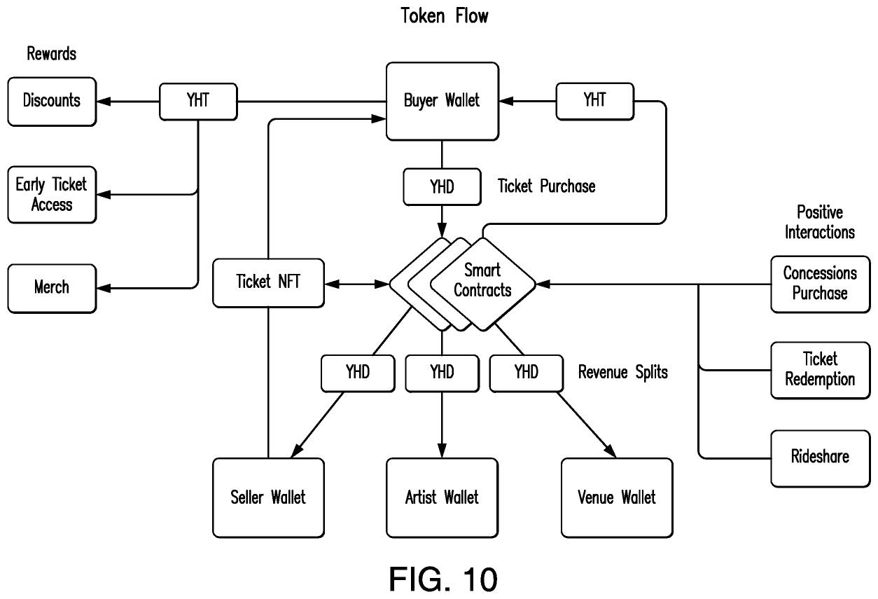

With reference now to FIG. 10, an exemplary token flow diagram is shown. The token flow diagram represents an exemplary embodiment of the flow of YHT, YHD, and the non-fungible token (e.g., live event non-fungible token), as taught herein. The token flow diagram, as shown in FIG. 10, is exemplary and non-limiting; it can be appreciated that the flow of YHT, YHD, and non-fungible tokens, and their interoperability, may be achieved in various ways according to various embodiments.

As tickets are “tokenized” on the blockchain 110, they may appear as digital representations in a user's electronic wallet (e.g., wallet 202 in FIG. 2A). “Tokenized”, as taught herein, may refer to the digital representation of the live event ticket or live event asset within a smart contract. When a newly created digital ticket is created, this may be referred to as “minting” a new token. “Minting” may refer to the act of newly creating a digital ticket or tokenized asset via a smart contract. For example, a baseball game ticket that is not on the platform yet may be “minted” and turned into a newly created digital ticket is represented on the platform as a non-fungible token.

During exemplary operation of the platform, and while using YHT, the platform itself may be configured and designed to incentivize and distinguish real users from fake users (e.g., real fans from bots or scalpers). In implementation of the YHT tokens, rewards may be granted in (but not limited to) the following cases:

After redeeming a ticket and therefore attending an event;

After purchasing artist or team merchandise in or out of venue;

Participating in offers in or surrounding the event venue;

Selling unused tickets at or below face value; and

Promoting an event in a positive relevant way on social media.

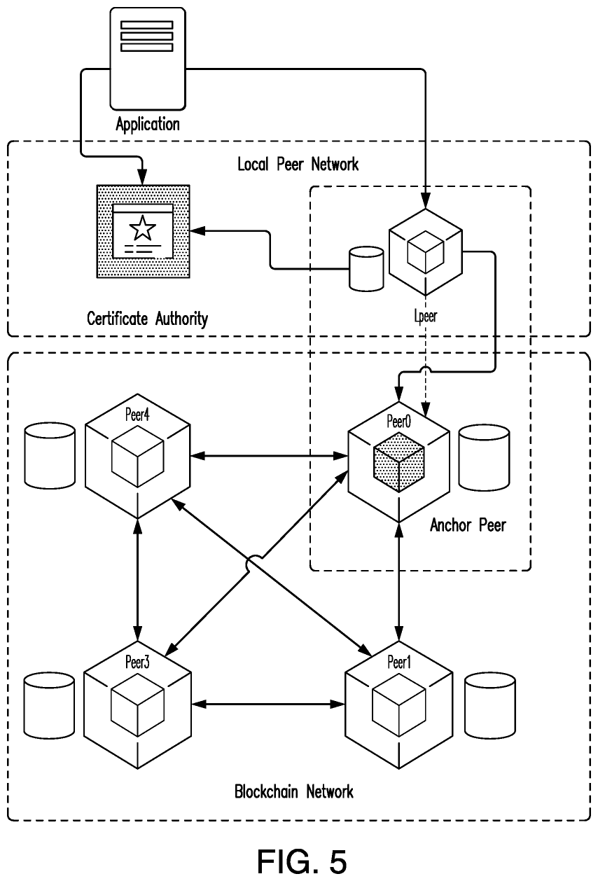

The YHT token system may then be used by a user (e.g., fans) in various other ways, for example: early access to tickets; access to exclusive band or team promotions; exchangeable with other fans; and provide discounts on things like transportation/rideshares to and from the venue, and merchandise. Because the YHT system is a fungible token, the YHT may be traded like currency on exchanges (e.g., Coinbase or Binance). FIG. 6 depicts an illustrative schematic of an exemplary operation of the platform taught herein. As shown, the platform's public blockchain may interact with at least: an artist, a promoter of a live event, and a user (e.g., a fan). Secondary markets, as shown, may also interact with the artist, promoter, and/or fan. Additionally, venues and artist may interact with the public blockchain. For example, a venue or an artist may change the rules of the smart contracts on the public blockchain to restrict or control the sale of tickets on the platform.

### Identification

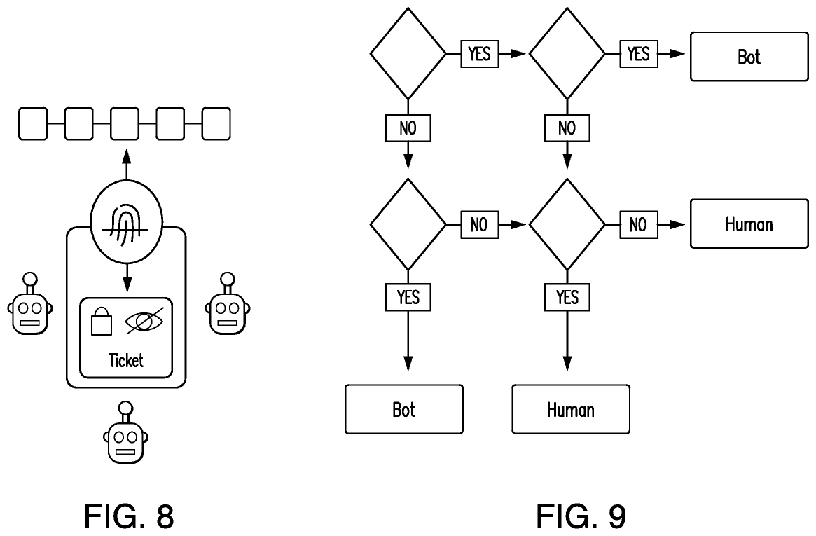

With reference now to FIGS. 8 and 9, in an exemplary embodiment, and according to an aspect of the present disclosure, the system 100 may include a federated biometric-based user identification for added security of the system 100. This biometric-based ID, as shown in FIG. 8, may be used to secure and recover wallets or purchased tickets. In an exemplary feature of the biometric-based ID, a user may opt to secure their account by providing biometric data, for example, a face or a fingerprint. In other exemplary embodiments, additional documents, like a passport or a driver's license, may be provided to the application 102. Passport and driver's license photos may be compared via facial recognition algorithms to the application user (via phone camera or webcam) to confirm they are in fact the same person. In other embodiments, and as depicted in FIG. 9, liveliness testing, and other mechanisms, may ensure a user is a real, living human, and not a robot (e.g., bot) or photo or another fraudulent actor. In doing so, the system 100 can establish strong confidence in the user's identity. In yet another exemplary embodiment of the biometric-based ID, a unique ID for a user may be created, which can only be generated by that user's unique identity. This unique ID may be stored on the blockchain 110 in association with the user's wallet and/or public address. By doing so, the user's wallet is secured, a wallet recovery mechanism is provided. In an exemplary embodiment, if the user's phone and/or keypair is lost or stolen, the user may transfer their old wallet to a new wallet (with a new keypair) by simply repeating the verification process. This is a significant improvement over key pairs alone, which is the way current blockchain systems operate (e.g., Bitcoin). In this case, if the user were to lose his key pair, the user would lose access to their wallet. In such a scenario, a thief would then have complete access to the user's wallet and the user have no recourse. However, the present biometric-based ID described herein not only secures a user's wallet, but also works to eliminate bots.

### Secondary Market Revenue Capture

As described herein, the system 100 may be used to provide a platform to generate a secondary market revenue share. This secondary market revenue share may be re-distributed to event stakeholders that may consist of artists, promoters, and/or venues. According to an aspect of the present disclosure, a user (e.g., fan) may purchase an event ticket, as taught herein, at the initial on-sale for face value. At a future point, the user may no longer wish to attend the event and may opt to place the event ticket back up for re-sale (e.g., on the secondary market). In such a scenario, the user may select or choose a target price that is above face value, which is common. This price, however, must fall within the allowed resale pricing rules, as governed by the “Rules” described herein. Subsequently, the user may be informed of the resale price distribution rules. The rules may include: 1) an initial purchase price that may be paid to the user; 2) the setting of an uplift price that is equal to the target price, or on-sale price; 3) and establishing distribution rules for an artist, promoter and venue share in the uplift price as defined on the event ticket ruleset (e.g., the artist and venue will participate in 25% and 5% of uplift revenue, respectively). At a later point, on the system 100, a second user, that is not the first user (e.g., another fan) purchases the resale ticket at the target price. At such an event, the resale funds may be settled according to the distribution rules outlined in the rules described above.

With continuing reference to FIG. 1, the user application 102 may be referred to as a “YellowHeart User Application”, in an exemplary embodiment of the platform as taught herein. The “smart contracts” 104, 140 may be governed, as depicted in FIGS. 1, 2A, and 7, by each transaction prior to its addition to the blockchain 110. In an exemplary embodiment, all parties may monitor the comprehensive transaction history in real-time to validate ticket ownership. In some embodiments, revenue distribution may also be viewed or monitored. According to an exemplary use case of the system 100, entries to the blockchain 110 may be continuously added as new transactions occurs. For example, as each new event is created (e.g., a new sporting event or concert), as each tickets/token is purchased, or as an ownership interest of a current ticket/token is transferred, a new entry to the blockchain 110 is added. In doing so, the system 100 provides an authenticated, secure, public, and decentralized platform for the buying and/or selling of live tickets.

### Addressing Bots and Bad Actors

According to aspects of the present disclosure, and with reference now to FIGS. 8 and 9, the platform described herein may be used to address unauthorized brokers, such as bots and scalpers, from driving up ticket prices. For example, the ticketing industries bad bot problem is unique. The average percentage of nefarious bots on ticketing domains is nearly double that of all domains at large. During ticket on-sales the percentage of bots can go even higher. A multi-prong approach may be utilized by the platform, as taught herein, to solve this. In an exemplary embodiment, a user's identity may be tracked or verified to ensure the purchaser is a real human, and not a bot. Economic disincentives, artificial behavior modeling, and other traditional defenses may also be used by the platform taught herein to counter bot activity.

According to an exemplary embodiment of the platform, a user's (e.g., fan's) identity may need to be verified before allowing access to the platform and/or purchasing a non-fungible token. For example, a fan's identity may be associated with a specific device fingerprint and cryptographic public/private key pair, as shown in FIG. 8. The public/private key pair may be used to identity a user's blockchain address, sign transactions, and/or verify transaction authenticity. In an exemplary embodiment, the platform, as taught herein, may use third party identity verification. The private key may be stored in special hardware on a device and may not be viewed directly even by the application, as shown in FIG. 1. Requests must be signed with this key. In this example, a signature can only be obtained by calling a special native method that requires a biometric (e.g., a fingerprint or face recognition) to access. In this way, the platform ties identity, mobile device fingerprint and cryptographic keys together making it impossible for bots to operate without a real identity or on any other device. “Smart contracts”, as taught herein, may ensure that only verified persons and their authorized devices can purchase and or hold tickets. The foregoing techniques may be implemented by the system 100 to reduce bot effectiveness.

In an exemplary embodiment, and according to aspects of the present disclosure, the platform 100 may also include exemplary behavior model(s) to combat robots (e.g. bot(s)). In such a model, a “real-time” interaction ML model may be used to distinguish a human from a bot. In an exemplary embodiment, the platform may forensically examine the behavior of a given identity. Based on data collected by the platform, the platform may determine what entities or persons are buying, selling, transferring, and ultimately redeeming a given ticket or tickets. Redeeming may refer to the act of entering a live-ticket event using the non-fungible token (e.g., ticket) taught herein.

In an exemplary embodiment, the platform, as taught herein, may use behavior modeling. Behavior models come in two “flavors” real time interaction and forensic analysis. In the platform taught herein, data procured by the platform may be used to determine which what or who buys, sells, transfers and ultimately redeems any given non-fungible token (e.g., live event ticket). By utilizing this AI-based behavior modeling, the platform can identify individuals or users that only buy, sell or hold tickets, but never redeem them. When such bad actors are detected by the platform or system 100, the platform will revoke these bad actors. In doing so, this may catch not only bots, but human scalpers, as well

Other methods or techniques may be used by the platform to counter bot and/or scalper activity. For example, economic disincentives may also be used by the platform. In a step, the platform may utilize various forms of restrictions that may be toggleable or configurable by a user, such as an artist. For example, in an embodiment, an artist may place restrictions on re-sale prices and other methods to increase competition overall and to keep ticket prices low. An artist may utilize the rule-based commerce using blockchain, as taught herein, to do so. Lastly, the platform may utilize traditional defenses, such as, for example, requesting rate limiting, blocking known hosting providers and proxy services that are nefarious, monitoring failed login attempts, placing transfer restrictions, and/or limiting the total number of tickets a given identity (e.g., single fan, single user, etc.) can purchase. Other traditional defenses to curb nefarious activity by scalpers and/or bots may also be utilized by the platform taught herein.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

We claim:

1. A system for electronic commerce in a distributed computing system with blockchain protocols and smart contracts, comprising:
a decentralized public permission-less online platform for the electronic commerce of secure digital assets, wherein the secure digital assets are managed by the blockchain protocols and the smart contracts; and
an external truth source.

2. The system of claim 1, wherein the external truth source is a decentralized oracle network.

3. The system of claim 1, wherein each secure digital asset is a live event ticket, and wherein said live event ticket corresponds to a specific live event.

4. The system of claim 1, wherein the external truth source is utilized by the platform to authenticate an interaction between a third party and the platform, and subsequently, if verified by the external truth source, transmit that verification to the blockchain to complete a transaction on the platform.

5. The system of claim 1 further comprising an identity verification module, wherein the identity verification module utilizes the external truth source to authenticate the identity of a third party interacting with the platform.

6. The system of claim 1 further comprising a payment verification module, wherein the payment verification module utilizes the external truth source to authenticate a payment transaction by a third party interacting with the platform.

7. The system of claim 3, wherein the information about a specific live event and the rules governing the live event ticket for that event are first configured by a third-party ticket issuer and after which the information and rules are codified in a corresponding smart contract that is deployed on the blockchain.

8. The system of claim 7, wherein the rules for each smart contract on the blockchain are enforced by the online platform.

9. The system of claim 4, wherein implementation of the blockchain protocols comprises a main blockchain utilizing a first authentication algorithm, a decentralized layer II sidechain utilizing a second authentication algorithm, and a transfer gateway, and wherein the decentralized layer II sidechain is attached to the main blockchain via the transfer gateway.

10. The system of claim 9, wherein the first authentication algorithm is a proof-of-work algorithm.

11. The system of claim 10, wherein the second authentication algorithm is a proof-of-stake algorithm.

12. The system of claim 9, wherein the smart contracts are stored on the decentralized layer II sidechain.

13. The system of claim 12, wherein a plurality of blockchain transactions involving smart contracts are first processed on the decentralized layer II sidechain utilizing the second authentication algorithm and then a block consisting of those plurality of blockchain transactions is subsequently processed on the main blockchain utilizing the first authentication algorithm.
